(19) United States
(12) Patent Application Publication
(10) Pub. No.: US 2015/0181653 A1
(43) Pub. Date: Jun. 25, 2015

(54) POLYMERIC PANEL HAVING AN ELECTRICALLY CONDUCTIVE STRUCTURE

(71) Applicant: SAINT-GOBAIN GLASS FRANCE, COURBEVOIE (FR)

(72) Inventors: Lothar Lesmeister, Landgraaf (NL); Andreas Schlarb, Wuppertal (DE)

(21) Appl. No.: 14/361,689

(22) PCT Filed: Nov. 2, 2012
(86) PCT No.: PCT/EP2012/071691

§ 371 Date: May 29, 2014

(30) Foreign Application Priority Data
Dec. 20, 2011 (EP) 11194449.2

(51) Int. Cl. H05B 3/84; H05B 3/06

(52) U.S. Cl. CPC H05B 3/84; H05B 3/06

(57) ABSTRACT

A polymeric panel having an electrically conductive structure is described. The polymeric panel has a polymeric substrate having at least one conductor track on a surface of the polymeric substrate, at least one electrically conductive resilient contacting rail electrically connected to a portion of the conductive track that is arranged between the polymeric substrate and the contacting rail, and at least one fastening element by means of which the contacting rail is clamped onto the surface of the polymeric substrate.

The invention relates to a polymeric panel having an electrically conductive structure, a method for its production, and its use.

Windows of motor vehicles are frequently provided with electrically conductive structures by which, for example, heating or antenna functions are performed. In the case of panes made of glass, such electrically conductive structures can be printed, for example, in the form of a silver-containing paste onto the panel surface and partially baked as heating or antenna conductors. By means of busbars likewise printed and connection elements soldered thereon for connection to the onboard electrical system, a stable electrical contacting of the conductors can be obtained.

In the auto industry, to reduce vehicle weight, glazings made of plastic are increasingly used, for example, as rear windows, side windows, or roof panels. With such panels, a heating or antenna function can also be desired. For plastic windows, printed electrically conductive structures have also been proposed, for example, in U.S. Pat. No. 5,525,401 A. However, no screen printing pastes are available that can be printed onto plastic surfaces in industrial production that are as electrically conductive as is necessary for effective heating.

Electrically conductive structures for plastic panels can be realized in the form of thin wires. The wires and, optionally, busbars can be applied on a thin plastic film, which is then connected to the panel body. For this, the plastic film is adhesively bonded to a previously produced panel body or placed in an injection mold and connected to the panel body by film insert molding. Such solutions are known, for example, from DE 35 06 011 A1, EP 7 857 Bl, and DE 101 47 537 A1. The wires are securely fixed between the plastic film and the panel body and protected against damage. However, the wires and, optionally, the busbars cannot be easily connected to the onboard electrical system since they are not accessible from the outside. The ends of the wires or the busbars or a plug connector connected to the wires can be guided out over the panel edge and electrically contacted there. However, since, in the installed position, the panel is typically surrounded along the edge by a frame, the electrical contacting is rendered more difficult and is susceptible to damage.

DE 199 27 999 A1 discloses a a synthetic resin window that is produced by film insert molding of a synthetic resin film provided with an electrical conductor. A hole is provided in the film for electrical contacting. A metal layer or a metal plate that is fixed between the film and the panel body and makes contact with the conductor is arranged in the region of the hole. The metal layer can be contacted through the hole by a connection element that is fastened on the panel body by fastening pins on the surface of the panel body or by claws on the underside of the connection element. The production of the window is, however, complicated and error-prone due to the introduction of the metal layer as the connection between the electrical conductors and the connection element. Since the metal layer is introduced into the window during film insert molding, the method of the electrical contacting is limited to windows that were produced according to the teaching of DE 199 27 999 A1.

Wires can also be introduced directly into the surface of a plastic panel, which is known, for example, from US 2006/0232972 A1. Here, a heating wire is thermally embedded into the surface of the plastic body. Each end of the heating wire is welded to an electrical connection element that is fastened on the plastic body. The electrical contacting is error-prone: If, for example, the electrically conductive connection between the two connection elements is interrupted by a break in the heating wire, the heating function fails completely. Moreover, US 2006/0232972 A1 does not teach how the connection element can be reliably fastened on the panel body.

The object of the present invention is to provide a polymeric panel having an electrically conductive structure as well as a method for its production, wherein the electrically conductive structure is simply and reliably contacted electrically.

The object of the present invention is accomplished according to the invention by a polymeric panel having an electrically conductive structure according to the independent claim 1. Preferred embodiments emerge from the subclaims.

The polymeric panel according to the invention having an electrically conductive structure comprises at least the following characteristics:
a polymeric substrate with at least one conductor track on a surface of the polymeric substrate,
at least one electrically conductive, elastic contacting rail, which is electrically connected to a part of the conductor track arranged between the polymeric substrate and the contacting rail, and
at least one fastening element, by means of which the contacting rail is clamped onto surface of the polymeric substrate,
   wherein the fastening element is formed in one piece with the polymeric substrate.

One surface of the polymeric substrate is implemented such that the fastening element according to the invention or the fastening elements according to the invention are provided as a part of the polymeric substrate. Thus, in the context of the invention, the fastening elements are formed in one piece with the polymeric substrate. The fastening elements are not elements separate from the substrate that have to be connected to the substrate, for example, by adhesion or by bolting.

The polymeric substrate is preferably prepared by injection molding. In that case, the injection mold has indentations on a surface facing the interior. To produce the polymeric substrate, the molten polymeric material is injected into the interior of the injection mold. After the curing of the polymeric material, the polymeric substrate can be removed from the mold. By means of the indentations in the mold, structures that serve according to the invention as fastening elements for the contacting rails are arranged on a surface of the polymeric substrate.

Alternatively, the polymeric substrate can, for example, be prepared in a first injection molding step with a smooth surface, and the fastening elements can subsequently be injected onto the smooth surface in the second injection molding step.

According to the invention, the contacting rail is elastic. This means that the contacting rail is stable in shape and returns, after deformation below the elastic limit, for example, slight bending, to its original shape upon removal of the force.

According to the invention, the contacting rail is electrically conductive. Consequently, an electrical connection of the conductor track to an external electrical system, for example, a voltage source, can be realized via the contacting rail. The conductor track includes a part that is arranged between the contacting rail and the surface of the substrate and that makes electrically conductive contact with the contacting rail. The conductor track is connected to the contacting rail at least via its side facing away from the polymeric substrate. An electrical contact surface of the conductor track, via which the electrically conductive connection between the conductor track and the contacting rail is provided, is thus turned away from the surface of the substrate. Thus, advantageously, simple electrical contacting of the conductor track is obtained by means of the connecting rail clamped from above onto the surface of the substrate.

Due to the elasticity of the contacting rail clamped onto the surface of the substrate, pressure that ensures a durably stable electrical connection between the contacting rail and the conductor track is maintained on the conductor track. The connection is clearly more stable than, for example, with electrical contacting of the conductor track by means of an electrically conductive adhesive. This is a major advantage of the invention. Since the clamping of the contacting rail occurs by means of fastening elements already present on the substrate and formed in one piece with the substrate, no further work steps, such as, for instance, drilling or soldering, which possibly damage the substrate, are necessary. The contacting rail can be connected to the surface of the substrate durably stably in a very simple manner. This is another major advantage of the invention.

The contacting rail has at least one region intended for contacting with the conductor track and for clamping on the surface of the polymeric substrate. This region preferably has a rectangular base area. However, the region can also have a base area with a different shape, for example, the shape of a curved rectangle, an oval, an ellipse, or a circular segment. The thickness of the region of the contacting rail intended for clamping is preferably from 0.5 mm to 5 mm, particularly preferably from 1 mm to 3 mm. This is particularly advantageous with regard to the stability and the elastic deformability of the conducting rail. The width of the contacting rail is preferably from 3 mm to 50 mm, particularly preferably from 5 mm to 20 mm. This is particularly advantageous with regard to a stable connection between the contacting rail and the surface of the substrate and a stable electrical contacting of the conductor track. In the context of the invention, “width” refers to the dimension of the contacting rail along which the conductor track runs. The conductor track preferably runs along the entire length of the contacting rail, or along the entire length of the region of the contacting rail intended for clamping. This means that the conductor track has no interruption in the region between the substrate and the contacting rail. This is particularly advantageous with regard to simple production of the panel according to the invention and stable contacting of the conductor track.

The length of the contacting rail can vary widely and thus be ideally adapted to the requirements of the individual case. If a plurality of conductor tracks running in parallel are contacted using the contacting rail, the minimum length of the contacting rail results from the number of conductor tracks and the distance between adjacent conductor tracks. The length of the contacting rail is, for example, from 5 cm to 50 cm. In the installed position, the contacting rail is preferably arranged parallel to the surface of the substrate. Depending on the type of the fastening elements according to the invention, the contacting rail can also have holes, indentations, or other shape characteristics.

It is a particular advantage of the invention that a plurality of conductor tracks that preferably run parallel to each other can be electrically contacted in a simple and quick manner by means of one contacting rail. The attachment of other electrically conductive elements that connect the parallel conductor tracks to each other is thus unnecessary.

The contacting rail preferably contains tungsten, copper, nickel, manganese, aluminum, silver, chromium, cobalt, and/or iron, as well as mixtures and/or alloys thereof.

The contacting rail particularly preferably contains a metal or an alloy by means of which the elasticity of the contacting rail is ensured. The contacting rail preferably contains at least a high-grade steel, a chrome-containing stainless (“rust-free”) steel or a spring steel.

A profile can also be introduced into the contacting rail, for example, by stamping or milling. The surface of the contacting rail facing the substrate is then not flat, but, instead, has one or a plurality of elevations. The elevations have, for example, in the cross-section through the width of the contacting rail perpendicular to the surface of the substrate, the profile of a circular segment or an elliptical segment. The elevations preferably extend along the length of the contacting rail. The conductor track does not make contact with the contacting rail along the entire width of the contacting rail, but, instead, only with a region of the elevation. Thus, the pressure that the clamped contacting rail exerts on the conductor track is increased and the stability of the electrical contacting is advantageously increased. A locally defined, reproducible contacting region inside the surface of the contacting rail is advantageously obtained. Moreover, the contacting rail can, in this case, contain materials that do not per se ensure the elasticity of the contacting rail according to the invention because, advantageously, a stiffening of the contacting rail can be obtained by means of the profile introduced. The contacting rail can then contain, for example, copper.

The contacting rail is preferably coated with nickel, tin, copper, and/or silver. The layer thickness is preferably from 0.1 μm to 20 μm, particularly preferably from 6 μm to 12 μm. The particular advantage of the coating resides in an increased current load capacity and corrosion stability of the contacting rail.

The contacting rail can be provided with prestressing before clamping onto the surface of the substrate. For example, the contacting rail can be curved along its length. The contacting rail is preferably curved such that its ends point away from the substrate at the time of the connection to the substrate. By means of the prestressing, the contact pressing force of the contacting rail is increased and the stability of the electrical contacting is advantageously heightened.

The conductor track is connected via the contacting rail to external electrical systems that are arranged outside the panel. The electrical systems are, for example, amplifiers, control units, or voltage sources. A cable to the external electrical system can, for example, be connected to the surface of the region of the contacting rail facing away from the substrate, which region is provided for clamping onto the surface of the polymeric substrate, for example, by soldering, welding, gluing, crimping, or clamping.

In a preferred embodiment of the invention, the contacting rail includes a region that is provided for connecting to the external electrical system and which is positioned on the region provided for the clamping onto the surface of the polymeric substrate. In the context of the invention, this region is referred to as the “connection region”. The connection region is preferably positioned on one side edge of the region provided for the clamping and not arranged on the surface of the region provided for the clamping facing away from the substrate. This is particularly advantageous with regard to simple production of the contacting rail. The connection region is particularly preferably designed as a standardized flat blade connector onto which the coupling of a connection cable to the external electrical system can be plugged. The contacting rail then provides an interface to the external electrical system. The particular advantage resides in a simple and quick connection of the panel according to the invention to the external electrical system. Additional work steps, for example, the soldering or welding of the contacting rail to a connection element are not required. However, the connection region can, for example, also have a hole to which a cable to the external electrical system can be bolted. Alternatively, the cable to the external electrical system can be soldered, welded, cramped, or glued onto the connection region.

The polymeric substrate has, according to the invention, on one surface at least one fastening element formed in one piece with the substrate. Here, “surface” refers to the preferably smooth area apart from the fastening elements. The fastening elements are suitable, either per se or in conjunction with another element, for clamping the contacting rail onto the surface of the substrate. By means of the fastening elements, a durably stable connection of the substrate and the contacting rail is obtained. Thus, a durably stable electrical connection of the contacting rail and a part of the conductor track arranged between the contacting rail and the substrate is also obtained.

In an advantageous embodiment, the fastening element is designed as a hook. Such a hook preferably has a first part that is connected on the surface of the substrate and is arranged perpendicular or approx. perpendicular to the surface of the substrate. A second part, which extends in the direction of the contacting rail and is arranged at least partially on the side of the contacting rail facing away from the substrate, is connected to the first part of the hook. A contact pressing force is exerted via the second part on the contacting rail, preferably on the surface of the contacting rail facing away from the substrate. In principle, the contacting rail can be clamped onto the surface of the substrate by two such hooks if the two hooks are suitably arranged on opposite edges of the contacting rail. Preferably, a plurality of hooks are arranged around the contacting rail. The distance between two adjacent hooks along one edge of the contacting rail is preferably from 1 cm to 10 cm. That is particularly advantageous with regard to a stable clamp connection between the substrate and the contacting rail. The first part of the hooks preferably borders on the edge of the contacting rail. This prevents slippage of the contacting rail parallel to the surface of the substrate. According to the invention, the shape and dimensioning of the hooks is selected such that the contacting rail is stably clamped onto the surface of the substrate and has no freedom of movement perpendicular to the surface of the substrate. The dimensioning of the hooks depends in particular in the individual case on the thickness of the contacting rail. The width of the hooks along the edge of the contacting rail is preferably from 1 mm to 10 mm. For the clamping, the contacting rail is preferably pressed between the hook-shaped fastening elements against the surface of the substrate, an action typically associated with a temporary bending of the fastening elements. The dimensioning of the fastening elements, in particular the material thickness of the fastening elements and the shape and size of the second part of the hooks, is selected such that such a reversible bending is possible without damage to the fastening elements.

In an alternative advantageous embodiment, the fastening element is formed as a pin that is arranged perpendicular or approx. perpendicular to the surface of the substrate. The pin can, for example, have a triangular, rectangular, oval, or polygonal, preferably circular cross-sectional surface parallel to the surface of the substrate. The length and width of the pin parallel to the surface of the substrate is preferably from 2 mm to 10 mm. This is particularly advantageous with regard to a stable connection between the contacting rail and the substrate. The contacting rail has one or a plurality of holes through which the fastening elements are guided. The number, the relative arrangement, the shape, and the size of the holes in the contacting rail are suitably selected for that. The height of each fastening element is suitably selected such that the fastening element protrudes beyond the contacting rail. After pressing the contacting rail onto the surface of the substrate, the contacting rail is durably stably clamped onto the surface of the substrate by means of the at least one fastening element. For this purpose, the tip of each fastening element pointing away from the substrate is, for example, heated and suitably deformed such that the contacting rail has no freedom of movement perpendicular to the surface of the substrate. Preferably, a fixing element, via which a contact pressing force is exerted on the contacting rail, is attached, preferably inserted into each fastening element. The fixing elements preferably contain at least a metal or an alloy, for example, steel, but can also contain a polymer. Suitable fixing elements are, for example, Starlock® retaining rings. However, differently designed fixing elements that do not disengage from the fastening elements in the installed position can also be used.

In principle, the contacting rail can be clamped onto the surface of the substrate by a fastening element with an inserted fixing element. For example, a contacting rail formed flat can be clamped with a single fastening element onto a curved polymeric substrate. The elastic contacting rail is bent by the clamping onto the curved substrate. The elasticity of the contacting rail results in a contact pressing force of the contacting rail onto the polymeric substrate. Thus, a durably stable electrical contacting of the conductor track is provided.

Preferably, the contacting rail is clamped onto the surface of the substrate by at least two fastening elements with fixing elements inserted. Thus, the stability of the electrical contacting of the conductor track is advantageously increased. Particularly preferably, a plurality of fastening elements are arranged along the length of the contacting rail. A plurality of rows of fastening elements can also be arranged along the length of the contacting rail. The distance between two adjacent fastening elements is preferably from 1 cm to 15 cm, for example, 10 cm. This is particularly advantageous with regard to a stable clamping connection between the substrate and the contacting rail.

The electrical connection between the external electrical system and the conductor track is made according to the invention via the electrically conductive contacting rail. In an advantageous embodiment, an additional busbar is arranged between the surface of the substrate and the conductor track in the region of the contacting rail and/or between the contacting rail and the conductor track. The particular advantage of the busbar or of the busbars resides in improved electrical contacting, in particular when a plurality of conductor tracks are electrically connected to the contacting rail.

The busbars preferably contain tungsten, copper, nickel, manganese, aluminum, silver, chromium, tin, and/or iron, as well as mixtures and/or alloys thereof, particularly preferably tungsten and/or copper. The busbars preferably have a thickness from 10 μm to 200 μm, particularly preferably from 50 μm to 100 μm. The width of a busbar, along which the busbar is connected to the conductor track, is preferably from 2 mm to 100 mm, particularly preferably from 5 mm to 20 mm. The length of the busbars can vary widely and thus be ideally adapted to the requirements in the individual case. If a plurality of conductor tracks running in parallel are contacted, the minimum length of the busbars results from the length of the busbars, from the number of conductor tracks, and from the distance between adjacent conductor tracks. The length of the busbars is, for example, from 5 cm to 50 cm.

The busbars are preferably coated with nickel, tin, copper, and/or silver. The layer thickness is preferably from 0.1 μm to 20 μm, particularly preferably from 6 μm to 12 μm. The particular advantage of the coating resides in an increased current load capacity and corrosion stability of the busbars.

A busbar between the surface of the substrate and the conductor track in the region of the contacting rail is preferably fastened to the substrate by a double-sided adhesive tape or an adhesive. The electrical connection of the busbar, conductor track, and contacting rail is thus advantageously made easier and the busbar is durably fixed on the surface of the substrate.

If one busbar is arranged in each case between the surface of the substrate and the conductor track in the region of the conducting rail and between the contacting rail and the conductor track, the two bus bars can be connected to each other by means of soldering compound. The conductor track is then embedded in the soldering compound, a situation which advantageously effects an improved and more stable electrical contacting even when the conductor track itself is not solderable. Preferably, a leadfree soldering compound is used since due to the Directive on End-of-Life Vehicles 2000/53/EC, lead-containing solders must be replaced by leadfree solders within the EC. The soldering compound preferably contains tin and bismuth, indium, zinc, copper, silver, or compositions thereof. The fraction of tin in the solder composition is from 3 wt.- % to 99.5 wt.- %, preferably from 10 wt.- % to 95.5 wt.- %, particularly preferably from 15 wt.-% to 60 wt.- %. The fraction of bismuth, indium, zinc, copper, silver, or compositions thereof in the solder composition is from 0.5 wt.- % to 97 wt.- %, preferably 10 wt.- % to 67 wt.- %, with the respective fraction of bismuth, indium, zinc, copper, or silver possibly being 0 wt.- %. The solder composition can contain nickel, germanium, aluminum, or phosphorus at a fraction from 0 wt.- % to 5 wt.- %. The solder composition very particularly preferably contains Bi40Sn57Ag3, Sn40Bi57Ag3, Bi59Sn40Ag1, Bi57Sn42Ag1, In97Ag3, Sn95.5Ag3.8Cu0.7, Bi67In33, Bi33In50Sn17, Sn77.2In20Ag2.8, Sn95Ag4Cu1, Sn99Cu1, Sn96.5Ag3.5, or mixtures thereof.

In a preferred embodiment, the conductor track is applied on the polymeric substrate by means of ultrasonic embedding. A sonotrode is preferably guided by a multi-axis robot and forced-controlled tool balance over the inner side of the polymeric substrate. The force-controlled tool balance enables the adaptation of the position of the sonotrode to the three-dimensional geometry of the polymeric substrate. The sonotrode transmits high-frequency mechanical oscillations (ultrasound) generated by an ultrasonic generator to the polymeric substrate. Heat is generated and a surface layer of the inner side of the polymeric substrate is melted. The conductor track is introduced into the melted surface layer. For this, the sonotrode guides a heating wire on it, with the heating wire continuously supplied from a spool of wire near the sonotrode. A tool suitable as a sonotrode is known, for example, from U.S. Pat. No. 6,023,837 A.

The penetration depth of the conductor track into the polymeric substrate is preferably from 50% to 90%, particularly preferably from 60% to 75% of the thickness of the conductor track. The uncomplicated application of the conductor track using ultrasonic embedding is particularly advantageous with regard to a stable connection between the conductor track and the polymeric substrate.

At least one section of the conductor track is embedded into the polymeric substrate. The conductor track can be embedded along its entire length into the polymeric substrate. This is particularly advantageous with regard to a stable connection between the polymeric substrate and the conductor track.

In an advantageous embodiment of the invention, the region of the conductor track provided for electrical contacting with the contacting rail is not embedded into the polymeric substrate. In this case, an additional busbar can be arranged between the conductor track in the region of the contacting rail and the polymeric substrate.

However, the conductor track can also be applied on the polymeric substrate by other methods. The conductor track can, in principle, be applied on the polymeric substrate by all methods known to the person skilled in the art so long as the part provided for contacting with the contacting rail protrudes out of the surface of the polymeric substrate. The applicability of the electrical contacting according to the invention by means of the contacting rail independently from the application of the conductor tracks is a major advantage of the present invention compared to the prior art. The conductor track can, for example, be pressed into the surface of the polymeric substrate after heating of the polymeric substrate, and is, for example, described in DE 35 06 011 A1. The conductor track can also be applied on a polymeric carrier film, which is then glued to the polymeric substrate. If the conductor track is supposed to be embedded between the carrier film and polymeric substrate, at least one end of the conductor track must protrude beyond the edge of the carrier film in order to be accessible for contacting after the adhesive bonding of the carrier film to the substrate.

The conductor track contains at least one metal, preferably tungsten, copper, nickel, manganese, aluminum, silver, chromium, and/or iron, as well as mixtures and/or alloys thereof. The conductor track particularly preferably contains tungsten and/or copper. Particularly good results are thus obtained.

In a preferred embodiment, the panel according to the invention is a heatable panel. The conductor track is electrically conductively connected to two contacting rails according to the invention. Preferably at least two, but typically more conductor tracks are connected to the two connecting rails. Upon application of an electrical potential difference between the contacting rails, current flows through each of the conductor tracks. This heats the conductor tracks, which thus enable active heating of the polymeric panel.

A stable electrical contacting of the conductor tracks is advantageously provided by the two contacting rails. Each conductor track is electrically connected to the two contacting rails and is supplied with voltage independently of the remaining conductor tracks. Thus, advantageously, the damaging of one conductor track does not result in the complete failure of the active heating of the panel.

The thickness of the conductor tracks is preferably from 10 μm to 300 μm, particularly preferably from 25 μm to 150 μm. This is particularly advantageous with regard to the transparency of the polymeric panel, the heating power introduced, and the prevention of short circuits.

The conductor tracks preferably run rectilinearly between the two contacting rails. The conductor tracks can, however, also run, for example, wavelike, meanderingly, or in the form of a zigzag pattern between the two contacting rails. The distance between two adjacent conductor tracks is preferably constant over the entire length of the conductor tracks. However, the distance between two adjacent conductor tracks can also change in the path between the two contacting rails.

The conductor tracks can run in any desired direction, preferably horizontally or vertically.

The distance between two adjacent conductor tracks is preferably from 5 mm to 30 mm, particularly preferably 6 mm to 20 mm. This is particularly advantageous with regard to the transparency of the polymeric panel and the distribution of the heating power introduced via the conductor tracks. The length of the conductor tracks can vary widely and thus be readily adapted to the requirements in the individual case. The conductor tracks have, for example, lengths from 5 cm to 150 cm.

Adjacent conductor tracks can be connected to each other on the side of a contacting rail facing away from the other contacting rail. The conductor tracks can thus be applied in the form of a single heating wire on the polymeric substrate, with the heating wire, after application, comprising two or more sections that are provided as conductor tracks and that are connected loop-wise to each other. Each section of the heating wire provided as a conductor track is connected in the region of one end to the first contacting rail and in the region of the other end with the second contacting rail. Each section of the heating wire in the region of the contacting rails and between the contacting rails forms a conductor track.

Alternatively, adjacent conductor tracks can be not connected to each other on the side of a contacting rail facing away from the other contacting rail. Thus, the conductor tracks are applied on the polymeric substrate in the form of a plurality of heating wires, with each heating wire connected in the region of one end to the first contacting rail and in the region of the other end to the second contacting rail. Each heating wire comprises one conductor track in the region of the contacting rails and between the contacting rails.

More than two contacting rails can also be arranged on the polymeric substrate. Thus, for example, a plurality of heating fields independent of each other can be realized. For example, one part of the conductor tracks that forms a first heating field can be connected to a first and a second contacting rail and another part of the conductor tracks that forms a second heating field can be connected to a third and a fourth contacting rail. Two heating fields independent of each other can, for example, also be realized in that all conductor tracks are connected to a first contacting rail. One part of the conductor tracks that forms a first heating field is additionally connected to a second contacting rail and another part of the conductor tracks that forms a second heating field is additionally connected to a third contacting rail. Of course, even more than two heating fields independent of each other can be realized according to the invention.

The polymeric substrate is preferably flat or slightly or greatly curved in one or more spatial directions.

The polymeric substrate is preferably transparent at least in regions. The polymeric substrate can be colorless, colored, or tinted. The polymeric substrate can be clear or cloudy.

The polymeric substrate preferably contains at least polyethylene (PE), polycarbonates (PC), polypropylene (PP), polystyrene, polybutadiene, polynitriles, polyester, polyurethanes, polymethylmethacrylates, polyacrylates, polyester, polyamides, polyethylene terephthalate (PET), acrylonitrile butadiene styrene (ABS), styrene acrylonitrile (SAN), acrylonitrile styrene acrylester (ASA), acrylonitrile butadiene styrene-polycarbonate (ABS/PC), and/or copolymers or mixtures thereof.

The polymeric substrate particularly preferably contains polycarbonates (PC), polyethylene terephthalate (PET), and/or polymethylmethacrylate (PMMA). This is particularly advantageous with regard to the transparency, the processing, the strength, the weather resistance, and the chemical resistance of the polymeric substrate.

The polymeric substrate preferably has a thickness from 1 mm to 10 mm, particularly preferably from 3 mm to 5 mm. This is particularly advantageous with regard to the strength and processing of the polymeric substrate. The size of the polymeric main body can vary widely and is determined by the use according to the invention. Preferably, the polymeric substrate has an area from 100 cm² to 3 m², for example, 1.5 m², which is customary for window panes of motor vehicles and in the construction sector and the architecture sector.

For aesthetic reasons, it can be desirable for the electrical contacting of the conductor track by means of the contacting rail to not be visible through the polymeric substrate. To that end, for example, the polymeric substrate can be colored or blackened in the region of the contacting rail. The polymeric substrate can also, for example, be produced by multicomponent injection molding, with the polymeric substrate comprising, in the region on which the contacting rail is to be arranged, an opaque component which obscures the view of the electrical contacting through the polymeric substrate.

The opaque component of the polymeric substrate preferably contains at least one colorant. The opacity of the component is achieved by means of the colorant. The colorant can contain inorganic and/or organic dyes and/or pigments. The colorant can be colored or uncolored. Suitable colorants are known to the person skilled in the art and can, for example, be looked up in the Colour Index of the British Society of Dyers and Colourists and the American Association of Textile Chemists and Colorists. Preferably, a black pigment is used as the colorant, for example, carbon black, aniline black, bone black, iron oxide black, spinel black, and/or graphite. Thus, a black opaque component is obtained.

Alternatively, masking screen prints can be applied on a surface of the polymeric substrate.

In an advantageous embodiment of the invention, a protective coating is applied on the surface of the polymeric substrate facing away from the contacting rails to protect the panel according to the invention against environmental influences. Preferably used are thermally hardening or UV-hardening coating systems based on polysiloxanes, polyacrylates, polymethacrylates, and/or polyurethanes. The protective coating preferably has a layer thickness from 1 μm to 50 μm, particularly preferably from 2 μm to 25 μm. The particular advantage resides in the increased scratch resistance and weather resistance of the polymeric substrate due to the protective coating.

In addition to coloring compounds and pigments, the protective coating can also contain UV-blockers and preservatives as well as components to increase scratch resistance, for example, nanoparticles.

The protective coating can, for example, be applied to the outer side of the polymeric substrate by a dipping, flooding, or spraying method. After application, the protective coating is hardened preferably by temperature and/or UV light input.

Products suitable as a protective coating are, for example, AS4000, AS4700, PHC587, or UVHC300, provided by the company Momentive.

The object of the present invention is further accomplished according to the invention by a method for producing a polymeric panel having an electrically conductive structure, wherein at least:

a) a polymeric substrate is prepared, which includes, on one surface, at least one fastening element formed in one piece with the polymeric substrate,
b) at least one conductor track is attached on the surface of the substrate, and
c) at least one contacting rail is clamped onto the surface of the substrate in the region of the conductor track by means of the fastening element.

In an advantageous embodiment, the conductor track is attached on the surface of the substrate by ultrasonic embedding. In another advantageous embodiment, a busbar is attached, preferably glued on the surface of the substrate before the attachment of the conductor track. The busbar is positioned in the region of the surface of the substrate that is provided for the clamping on of the contacting rail. A sonotrode for the ultrasonic embedding of the conductor track can be guided beyond the busbar such that the conductor track is embedded into the surface of the polymeric substrate on both sides of the busbar.

The polymeric panel having an electrically conductive structure is preferably used as a panel or as a component of a panel of means of transportation for travel on land, in the air, or on water, in particular as a rear window, windshield, side window, roof panel, luminaire cover, and/or spoiler of automobiles and rail vehicles. The polymeric panel having an electrically conductive structure can also be used in functional and/or decorative individual pieces or as a built-in component in furniture and devices. The polymeric panel is used, in particular, as a panel with a heating and/or an antenna function, wherein the conductor track according to the invention or the conductor tracks according to the invention are used as heating conductors and/or as antenna conductors.

The invention is explained in detail with reference to drawings and exemplary embodiments. The drawings are schematic representations and not true to scale. The drawings in no way restrict the invention. They depict:

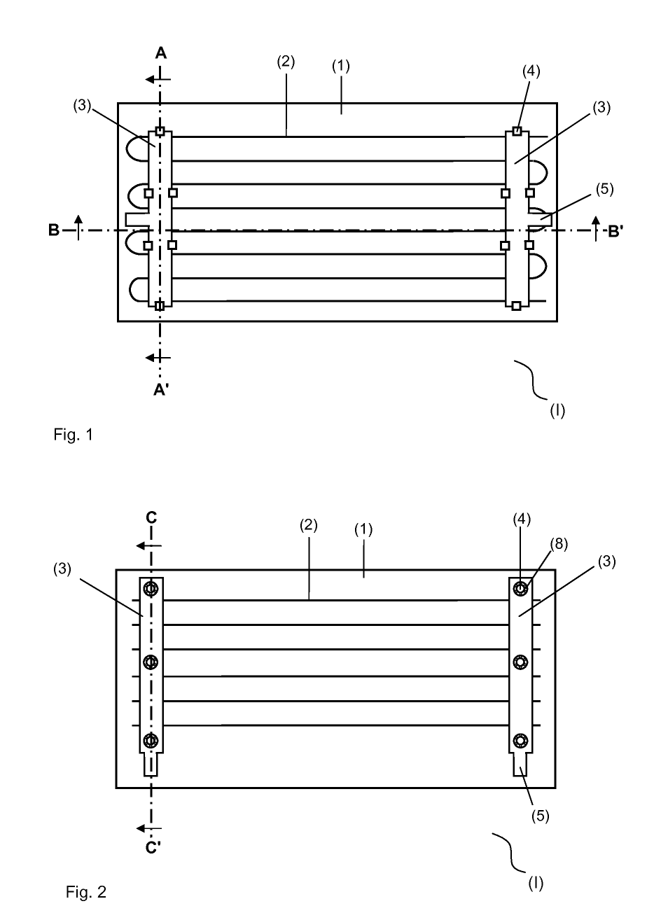

FIG. 1 a plan view of the first embodiment of the panel according to the invention,

FIG. 2 a plan view of another embodiment of the panel according to the invention,

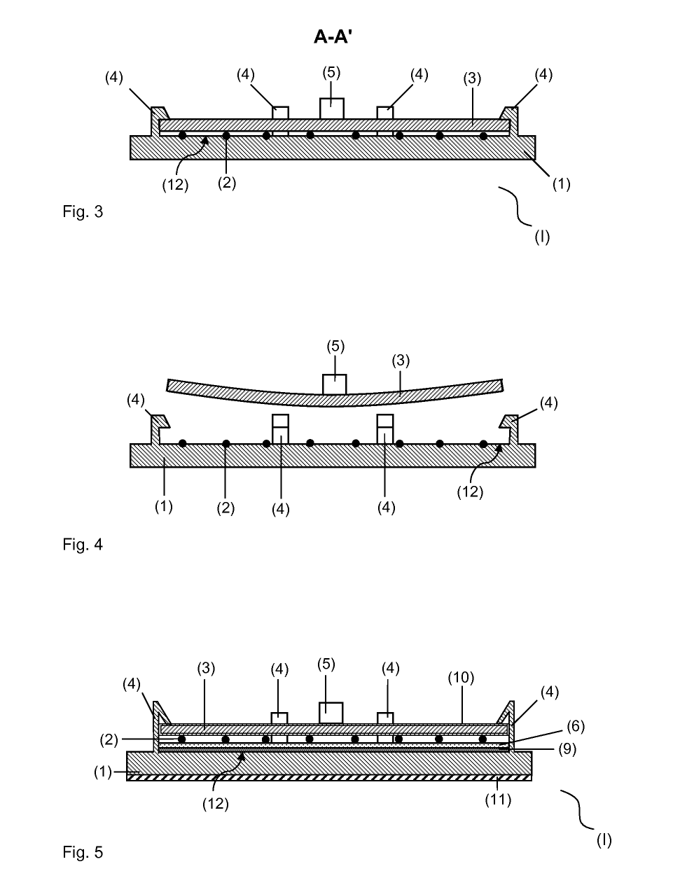

FIG. 3 a section along A-A′ through the panel of FIG. 1,

FIG. 4 a section along A-A′ through the panel of FIG. 1 before the clamping of the contacting rail,

FIG. 5 a section along A-A′ through another embodiment of the panel according to the invention,

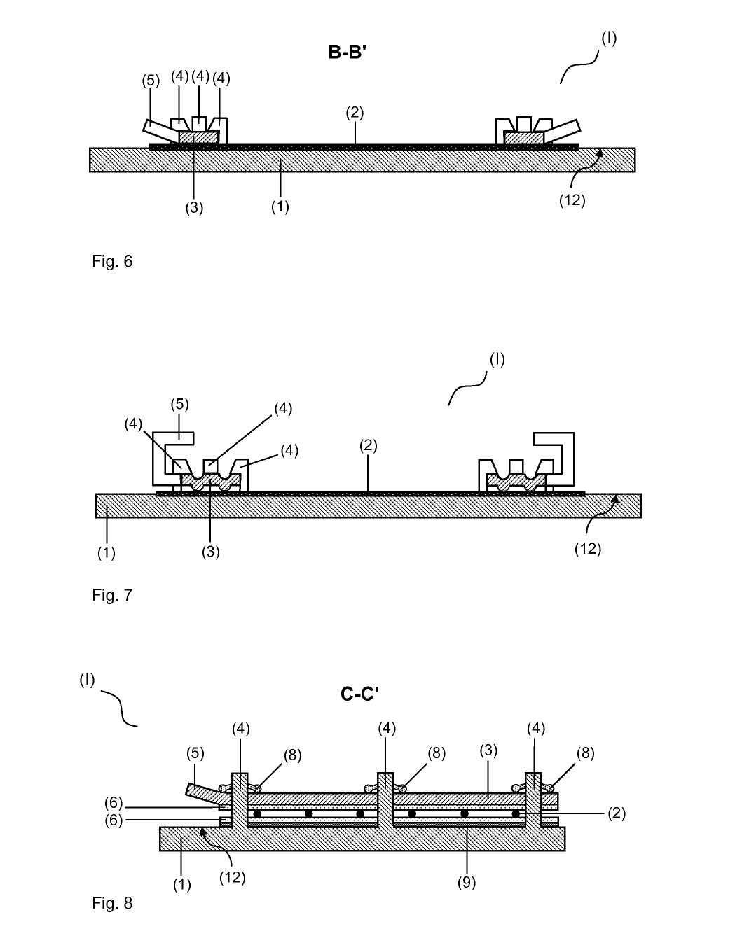

FIG. 6 a section along B-B′ through the panel of FIG. 1,

FIG. 7 a section along B-B′ through another embodiment of the panel according to the invention,

FIG. 8 a section along C-C′ through the panel of FIG. 2,

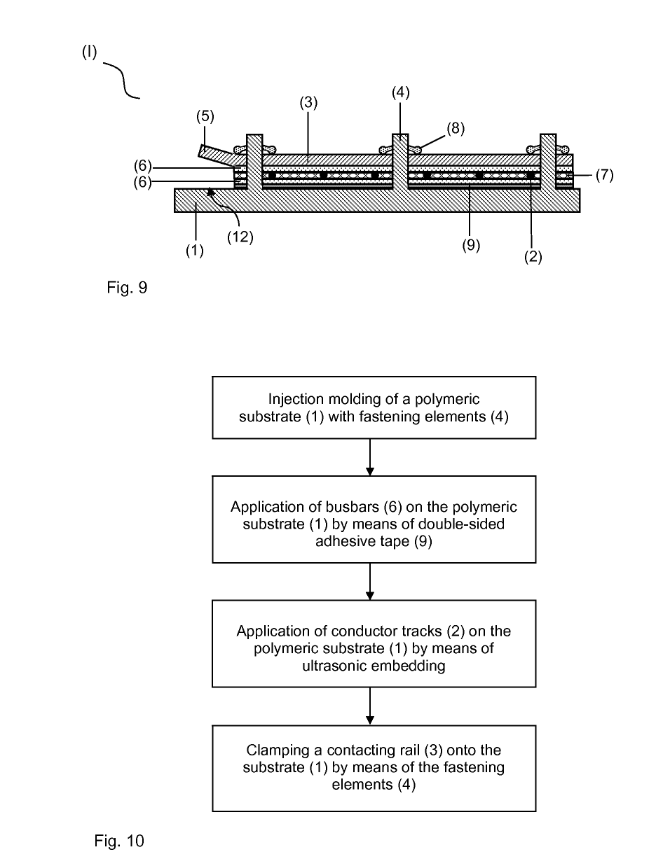

FIG. 9 a section along C-C′ through another embodiment of the panel according to the invention and

FIG. 10 a detailed flowchart of the method according to the invention for producing a polymeric panel having an electrically conductive structure.

FIG. 1, FIG. 3, and FIG. 6 each depict a detail of a polymeric panel (I) having an electrically conductive structure according to the invention. The polymeric panel (I) is provided as a heatable panel. The polymeric panel (I) contains a polymeric substrate 1. The polymeric substrate 1 contains polycarbonate (PC) and has a thickness of 4 mm. Eight conductor tracks 2 are arranged on a surface 12 of the polymeric substrate. The conductor tracks 2 are arranged parallel to each other and horizontally. The conductor tracks 2 contain tungsten and have a thickness of 70 μm. The distance between two adjacent conductor tracks 2 is 15 mm. The conductor tracks 2 are embedded by ultrasonic embedding over their entire length into the polymeric substrate 1, with the penetration depth being roughly 40 μm. The polymeric panel (I) also contains two contacting rails 3. The first end region of each conductor track 2 is electrically connected to the first contacting rail 3 and the second end region of each conductor track 2 is electrically connected to the second contacting rail 3. The end regions of the conductor tracks 2 are arranged between the polymeric substrate 1 and the contacting rail 3. The conductor tracks 2 are sections of a single heating wire that is applied on the polymeric substrate 1 in straight sections connected to each other loop-wise. Adjacent conductor tracks 2 are thus connected to each other by a region of the heating wire, wherein the connection takes place alternatingly on the side of the second contacting rail 3 facing away from the first contacting rail 3 and on the side of the first contacting rail 3 facing away from the second contacting rail 3.

The contacting rails 3 contain high-grade steel. The region of each contacting rail 3 provided for clamping onto the surface 12 of the polymeric substrate 1 has a rectangular base area with a width of 15 mm and a length of 80 mm. The thickness of the contacting rail is 1.5 mm.

The polymeric panel (I) also contains fastening elements 4, which are formed in one piece with the polymeric substrate 1. The fastening elements 4 are designed as hooks. Six fastening elements 4 are arranged surrounding each contacting rail 3. Each contacting rail 3 is durably stably clamped onto the surface 12 of the polymeric substrate 1 by the fastening elements 4. The contacting rails 3 are thus pressed against the conductor tracks 2, by which means a durably stable electrical connection is provided between the contacting rails 3 and the conductor tracks 2. A simple electrical contacting of the conductor tracks 2 is provided by the clamped-on contacting rails 3, with no complicated additional work steps such as soldering or welding being necessary and with a clearly more stable connection being achieved than, for example, by means of an electrically conductive adhesive.

Each contacting rail 3 includes a connection region 5 that is provided for the connection with an external voltage source (not shown). The connection region 5 is positioned on the longitudinal edge of the rectangular region provided for clamping onto the surface 12 of the polymeric substrate 1, which edge faces away from the other contacting rail 3, and is arranged to the side thereof. The connection region 5 is designed as a standardized flat blade connector onto which the coupling of a connection cable (not shown) to the power supply can be plugged. The contacting rail 3 thus advantageously provides an interface to the external power supply such that additional work steps, such as the soldering of the contact rail 3 to an electrical connection element, are unnecessary.

Upon application of a potential difference between the two contacting rails 3 current flows through each conductor track 2. The heat generated thereby enables active heating of the polymeric panel (I). By means of the electrical contacting separate from each other of the individual conductor tracks 2, damage to one conductor track 2 advantageously does not result in a complete failure of heating of the polymeric panel.

FIG. 2 and FIG. 8 each depict a detail of an alternative embodiment of the polymeric panel (I) according to the invention. Six heating wires are arranged as conductor tracks 2 on the surface 12 of the polymeric substrate 1. In the regions of the electrical contacting, the conductor tracks 2 are not embedded into the polymeric substrate 1. An additional busbar 6 is arranged between each contacting rail 3 and the conductor tracks 2. Another busbar 6 is arranged between the surface 12 of the substrate 1 and the conductor tracks 2 in the region of each contacting rail 3. The busbars 6 contain copper and have a thickness of 100 μm. The busbars 6 are tin plated. The length and width of the busbars 6 corresponds to the length and width of the contacting rails 3. The electrical contacting of the conductor tracks 2 is further improved by means of the busbars 6. The busbars 6 between the surface of the substrate 1 and the conductor tracks 2 are fixed on the substrate 1 by a double-sided adhesive tape 9.

Each contacting rail 3 is clamped onto the surface 12 of the polymeric substrate 1 by means of three fastening elements 4. The fastening elements 4 are designed as pins. The fastening elements 4 have a circular cross-sectional area parallel to the surface 12 of the substrate 1 with a diameter of 5 mm. The contacting rails 3 and the busbars 6 have circular holes through which the fastening elements 4 are guided. On each fastening element 4, a fixing element 8 is inserted on the side of the contacting rails 3 facing away from the substrate 1. The fixing element 8 is, for example, a Starlock® retaining ring (round shaft, item number 8153), which cannot be disengaged from the fastening element 4 after insertion. Each contacting rail 3 is durably stably clamped onto the surface 12 of the substrate 1 by the fastening elements 4 with the fixing elements 8. The contacting rails 3 are thus pressed against the conductor tracks 2, by which means a durably stable electrical connection between the contacting rails 3 and the conductor tracks 2 is provided.

The connection region 5 of each contacting rail 3 is positioned on a transverse edge of the rectangular region provided for clamping onto the surface 12 of the polymeric substrate 1.

FIG. 3 depicts a section along A-A′ through the polymeric panel (I) according to the invention of FIG. 1. The polymeric substrate 1, conductor tracks 2 embedded therein, a contacting rail 3, and the fastening elements 4 formed in one piece with the substrate 1 as well as the region 5 of the contacting rail 3 that is provided for the connection to an external voltage source can be seen.

FIG. 4 depicts the polymeric panel (I) of FIG. 3 before the clamping of the contacting rail 3 onto the substrate 1. The contacting rail 3 is curved along its length such that its ends point away from the substrate. The contacting rail 3 is thus provided with prestressing that is retained as a result of the elasticity according to the invention of the contacting rail 3 after the clamping. By means of the prestressing, the contact pressing force of the contacting rail 3 is increased and the stability of the electrical contacting is advantageously heightened.

For the clamping, the contacting rail 3 is pressed onto the surface 12 of the substrate 1 between the fastening elements 4. Thus, the fastening elements 4 are temporarily bent away from the contacting rail 3.

FIG. 5 depicts, in continuation of the exemplary embodiment of FIGS. 1 and 3, an alternative embodiment of the polymeric panel (I) according to the invention. In the regions of the electrical contacting, the conductor tracks 2 are not embedded into the polymeric substrate 1. In the region of each contacting rail 3, a busbar 6 is arranged between the surface 12 of the substrate 1 and the conductor tracks 2. The electrical contacting of the conductor tracks 2 is further improved by the busbars 6. The busbars 6 are fixed on the substrate 1 by a double-sided adhesive tape 9.

A first part of the hook-shaped fastening elements 4 is arranged roughly perpendicular to the surface 12 of the substrate 1. A second part, which extends in the direction of the contacting rail 3 and which is arranged on the side of the contacting rail 3 facing away from the substrate 1, is connected to the first part. In the exemplary embodiment depicted, the two parts of the fastening element 4 are arranged at an angle of roughly 30° relative to each other. Thus, a flexibility of the second part is obtained, which advantageously makes the attachment of the contacting rail 3 easier.

The contacting rail 3 is provided with a silver-containing coating 10 with a layer thickness of 10 μm. By this means, the current load capacity and corrosion stability of the contacting rail 3 are increased.

A protective coating 11 is applied on the surface of the polymeric substrate 1 facing away from the contacting rails 3. The protective coating 11 contains a thermally hardening varnish based on polysiloxane and has a layer thickness of 15 μm. By means of the protective coating 11, the polymeric substrate 1 is advantageously protected against environmental influences such as weathering and mechanical action.

FIG. 6 depicts a section along B-B′ through the polymeric panel (I) according to the invention of FIG. 1. The polymeric substrate 1, a conductor track 2 embedded therein, the contacting rails 3, and the fastening elements 4 formed in one piece with the substrate 1 as well as the region 5 of the contacting rail 3, which is provided for the connection with an external voltage source, can be seen.

FIG. 7 depicts, in continuation of the exemplary embodiment of FIGS. 1 and 6, an alternative embodiment of the polymeric panel (I) according to the invention. In this exemplary embodiment, the connection region 5 of each contacting rail 3 is arranged above the contacting rail 3. A profile is stamped into each contacting rail 3. As a result, the surface of the contacting rails 3 facing the substrate has two elevations, which have, in cross-section, the profile of a circular segment and which extend along the length of the contacting rail 3. The conductor tracks 2 make contact with the contacting rails 3 via a region of each elevation. Thus, the pressure that the clamped-on connecting rail 3 exerts on the conductor tracks 2 is increased and the stability of the electrical contacting is advantageously increased.

FIG. 8 depicts a section along C-C′ through the polymeric panel (I) according to the invention of FIG. 2. The polymeric substrate 1, the conductor tracks 2, a contacting rail 3 with the region 5 provided for connection to an external voltage source, and the busbars 6 as well as the fastening elements 4 formed in one piece with the substrate 1 with the fixing elements 8 can be seen.

FIG. 9 depicts, in continuation of the exemplary embodiment of FIGS. 2 and 8, an alternative embodiment of the polymeric panel (I) according to the invention. The two busbars 6 arranged in the region of a contacting rail 3 are connected to each other by means of a soldering compound 7. The soldering compound 7 contains 57 wt.- % bismuth, 42 wt.- % tin and 1 wt.- % silver. Although the tungsten-containing conductor tracks 2 themselves are not solderable, the conductor tracks 2 are embedded in the soldering compound 7. Thus, an improved and more stable electrical contacting is advantageously obtained.

FIG. 10 depicts a flowchart of an exemplary embodiment of the method according to the invention for producing a polymeric panel (I) having an electrically conductive structure.

Test specimens of the polymeric panel (I) according to the invention having an electrically conductive structure were produced. The polymeric substrates 1 were produced by injection molding with the fastening elements 4. Fastening elements 4 in accordance with FIG. 1 and FIG. 2 were used. Then, conductor tracks 2 were embedded in the surface 12 of the substrate 1 by means of ultrasonic embedding. Two contacting rails 3 were clamped onto the surface 12 of the substrate 1 by means of the fastening elements 4 and, in the process, brought into contact with the conductor tracks 2. The active heating of the polymeric panel (I) was enabled by the application of a potential difference between the contacting rails 3.

By means of the fastening elements 4 formed in one piece with the polymeric substrate 1, it was possible for the contacting rails 3 to be clamped onto the polymeric substrate 1 in a simple manner. The connection between the substrate 1 and the contacting rail 3 was durably stable. By this means, a durably stable electrical connection between the contacting rails 3 and the conductor tracks 2 was also obtained. The conductor tracks 2 contacted according to the invention enabled the removal of condensed atmospheric moisture and ice from the polymeric panel within a short time. Due to the electrical contacting of each conductor track 2 by means of the contacting rails 3, even intentionally caused damage of a single conductor track 2 did not result in the complete failure of the heating action.

It was unexpected and surprising for the person skilled in the art that a stable and readily installable electrical contacting of the conductor tracks 2 can be obtained in a simple manner.

### LIST OF REFERENCE CHARACTERS

(I) polymeric panel having an electrically conductive structure
(1) polymeric substrate
(2) conductor track
(3) contacting rail
(4) fastening element
(5) connection region of (3)
(6) busbar
(7) soldering compound
(8) fixing element
(9) double-sided adhesive tape
(10) coating of (3)
(11) protective coating of (1)
(12) surface of (1)
A-A′ section line
B-B′ section line
C-C′ section line

1. A polymeric panel having an electrically conductive structure, comprising:
a polymeric substrate with at least one conductor track on a surface of the polymeric substrate,
at least one electrically conductive, elastic contacting rail, which is electrically connected to a part of the conductor track arranged between the polymeric substrate and the contacting rail, and
at least one fastening element, by means of which the contacting rail is clamped onto the surface of the polymeric substrate,
wherein the fastening element is formed in one piece with the polymeric substrate.

2. The panel according to claim 1, wherein each fastening element is implemented as a hook adjacent the contacting rail.

3. The panel according to claim 1, wherein each fastening element is formed as a pin that is guided through a hole in the contacting rail and on which a fixing element is attached, preferably inserted.

4. The panel according to claim 1, wherein the contacting rail contains at least a high-grade steel, a stainless steel, and/or a spring steel and preferably has a thickness from 0.5 mm to 5 mm, particularly preferably from 1 mm to 3 mm.

5. The panel according to claim 1, wherein the contacting rail is provided with a coating, which contains at least nickel, tin, copper, and/or silver and preferably has a layer thickness from 0.1 μm to 20 μm, particularly preferably from 6 μm to 12 μm.

6. The panel according to claim 1, wherein, between a surface of the substrate and the conductor track in a region of the contacting rail and/or between the contacting rail and the conductor track, a busbar is arranged, which busbar preferably contains at least tungsten, copper, nickel, manganese, aluminum, silver, chromium, iron, tin, and/or alloys thereof and which preferably has a thickness from 10 μm to 200 μm, particularly preferably from 50 μm to 100 μm.

7. The panel according to claim 1, wherein, between a surface of the substrate and the conductor track in a region of the contacting rail and between the contacting rail and the conductor track, a busbar is in each case arranged and wherein the busbars are connected to each other via a soldering compound.

8. The panel according to claim 1, wherein the contacting rail includes a connection region, which is preferably designed as a standardized flat blade connector, for connection to an external electrical system.

9. The panel according to claim 1, wherein at least one elevation that runs along a length of the contacting rail is introduced into the surface of the contacting rail facing the substrate.

10. The panel according to claim 1, wherein at least one section of the conductor track is embedded into the polymeric substrate, preferably at a depth that is from 50% to 90%, preferably from 60% to 75%, of the thickness of the conductor track.

11. The panel according to claim 1, wherein the polymeric substrate contains at least polycarbonate, polyethylene terephthalate, and/or polymethyl methacrylate and preferably has a thickness from 1 mm to 10 mm, particularly preferably from 3 mm to 5 mm.

12. The panel according to claim 1, wherein the conductor track contains at least tungsten, copper, nickel, manganese, aluminum, silver, chromium, iron, and/or alloys thereof and preferably has a thickness from 10 μm to 300 μm, preferably from 25 μm to 150 μm.

13. A method for producing a polymeric panel having an electrically conductive structure, comprising:
preparing a polymeric substrate, which includes, on one surface, forming at least one fastening element in one piece with the polymeric substrate,
attaching at least one conductor track on the surface of the polymeric substrate, and
clamping at least one contacting rail onto the surface of the polymeric substrate in the region of the conductor track by means of the fastening element.

14. The method according to claim 13, wherein the conductor track is attached on the surface of the polymeric substrate by ultrasonic embedding.

15. A method comprising:
using the polymeric panel having an electrically conductive structure according to claim 1 in means of transportation for travel on land, in the air, or on water, in particular as a rear window, windshield, side window, roof panel, luminaire cover, and/or spoiler of automobiles and rail vehicles.
